(19) United States
(12) Patent Application Publication
(10) Pub. No.: US 2023/0314152 A1
(43) Pub. Date: Oct. 5, 2023

(54) SIMULATION DEVICE

(71) Applicant: HONDA MOTOR CO., LTD., Tokyo (JP)

(72) Inventors: Kei HIROHATA, TOKYO (JP); Hiroaki MARUYAMA, TOKYO (JP); Jun OHASHI, TOKYO (JP); Naohiro AKUZAWA, TOKYO (JP); Daisuke IDE, TOKYO (JP); Yohei UMEMOTO, TOKYO (JP); Adil GUPTA, TOKYO (JP); Yuichi NAKAMURA, TOKYO (JP)

(21) Appl. No.: 18/126,621

(22) Filed: Mar. 27, 2023

(30) Foreign Application Priority Data
Mar. 30, 2022 (JP) 2022-056685

(51) Int. Cl. G01C 21/34

(52) U.S. Cl. CPC G01C 21/3469; G01C 21/3492

(57) ABSTRACT

A simulation device is equipped with a travel information acquisition unit that acquires travel information from an internal combustion engine vehicle, a storage device that stores electric vehicle information about traveling performance of an electric vehicle, an electric energy calculating unit that calculates electric energy required when the electric vehicle is used, a ratio estimation unit that estimates a rechargeable ratio based on the electric energy and a parking time, and an output unit that outputs to an information terminal of a user the rechargeable ratio.

### CROSS-REFERENCE TO RELATED APPLICATIONS

This application is based upon and claims the benefit of priority from Japanese Patent Application No. 2022-056685 filed on Mar. 30, 2022, the contents of which are incorporated herein by reference.

### BACKGROUND OF THE INVENTION

### Field of the Invention

The present invention relates to a simulation device.

### Description of the Related Art

JP 2014-235709 A discloses an electric energy consumption estimating apparatus for estimating the electric energy in a battery consumed by an electric vehicle.

### SUMMARY OF THE INVENTION

According to the disclosure of JP 2014-235709 A, it is possible to estimate the electric energy required for daily use of an electric vehicle. However, there is a problem that a user cannot estimate how much electric energy out of the required electric energy can be supplied by charging at a parking lot at home or near home. Therefore, there are some users who hesitate to buy an electric vehicle to replace his/her internal combustion engine vehicle.

An object of the present invention is to solve the above-described problems.

According to an aspect of the present invention, a simulation device includes a travel information acquisition unit configured to acquire travel information from an internal combustion engine vehicle equipped with an internal combustion engine, the travel information including a travel history of the internal combustion engine vehicle, a storage device configured to store electric vehicle information about traveling performance of an electric vehicle, an electric energy calculating unit configured to calculate electric energy required when the electric vehicle is used during a predetermined period, based on the electric vehicle information and the travel information acquired during the predetermined period, a ratio estimation unit configured to estimate a rechargeable ratio in a storage location, based on the calculated electric energy and a parking time of the internal combustion engine vehicle in the storage location, and an output unit configured to cause an information terminal of a user of the internal combustion engine vehicle to output the rechargeable ratio.

According to the present invention, each user can recognize whether or not the electric vehicle is suitable for him/her.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram exemplifying a network connection configuration of a simulation device according to an embodiment;

FIG. 2 is a block diagram illustrating the configuration of the simulation device;

FIG. 3 is a diagram exemplifying travel information;

FIG. 4 is a diagram exemplifying electric vehicle information;

FIG. 5A is a diagram illustrating a state in which a user drives an electric vehicle from a home parking lot to a work place

FIG. 5B is a diagram illustrating how a user returns from the work place to the home parking lot by the electric vehicle.

FIG. 6 is a diagram for explaining the travel of the internal combustion engine vehicle during a predetermined period and parking time of the internal combustion engine vehicle in a parking lot;

FIG. 7 is a diagram illustrating a state where a rechargeable ratio is output to the information terminal of the user;

FIG. 8 is a flowchart illustrating a processing procedure relating to acquisition of travel information by the simulation device;

FIG. 9 is a flowchart illustrating a processing procedure relating to estimation of the rechargeable ratio by the simulation device;

FIG. 10 is a block diagram illustrating the configuration of the simulation device according to a modification;

FIG. 11 is a diagram illustrating a state where a rechargeable ratio is output to the information terminal of the user;

FIG. 12 is a flowchart illustrating a processing procedure relating to estimation of the rechargeable ratio and calculation of the average value by the simulation device.

### DETAILED DESCRIPTION OF THE INVENTION

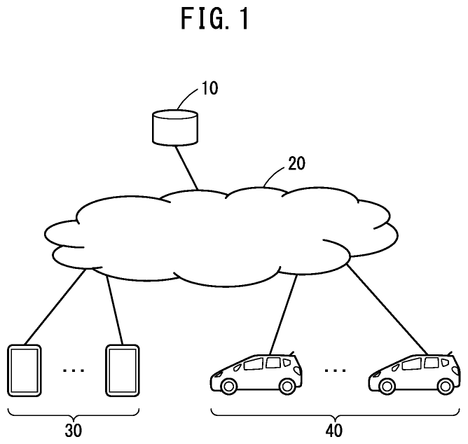

FIG. 1 is a diagram exemplifying a network connection configuration of a simulation device 10 according to an embodiment. Information terminals 30 of a plurality of users and internal combustion engine vehicles 40 of the plurality of users are connected to the simulation device 10 via a communication network 20.

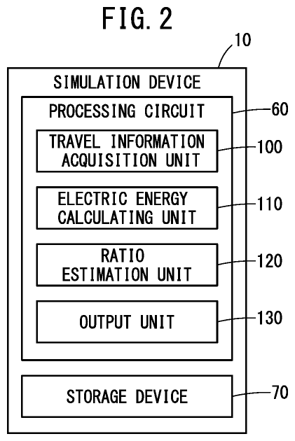

FIG. 2 is a block diagram illustrating the configuration of the simulation device 10. The simulation device 10 includes a processing circuit 60 and a storage device 70. The processing circuit 60 includes a processor such as a CPU or a GPU. The storage device 70 includes a volatile memory such as a RAM and a non-volatile memory such as a ROM or a flash memory. The volatile memory is used as a working memory of the processor. The non-volatile memory stores programs executed by the processor and other necessary data.

The processing circuit 60 includes a travel information acquisition unit 100, an electric energy calculating unit 110, a ratio estimation unit 120, and an output unit 130. When the processing circuit 60 executes the program stored in the storage device 70, the travel information acquisition unit 100, the electric energy calculating unit 110, the ratio estimation unit 120, and the output unit 130 are implemented. At least a part of the travel information acquisition unit 100, the electric energy calculating unit 110, the ratio estimation unit 120, and the output unit 130 may be implemented by an integrated circuit such as an ASIC or an FPGA or an electronic circuit including a discrete device.

The travel information acquisition unit 100 acquires travel information including each of travel histories of the internal combustion engine vehicles 40 from the internal combustion engine vehicles 40 used by the plurality of users. Based on the acquired travel information, the electric energy calculating unit 110 calculates a travel distance of each of the internal combustion engine vehicles 40 during a predetermined period (for example, one day, one week, etc.). Based on the calculated travel distance and electric power consumption of an electric vehicle, the electric energy calculating unit 110 calculates electric energy (amount of electric power) required when each of the users uses the electric vehicle during a predetermined period of time. The usage pattern of the internal combustion engine vehicle 40 by one of the users during the predetermined period is the same to some extent.

In the present embodiment, a user uses a parking lot at home (also referred to as a home parking lot) as a storage place for the internal combustion engine vehicle 40. In this case, it is assumed that when the user switches from the use of the internal combustion engine vehicle 40 to the use of an electric vehicle, the electric vehicle is stored in the home parking lot of user's on a daily basis. A storage location of the internal combustion engine vehicle 40 may be a parking lot other than the home parking lot of the user. For example, the storage location may be a parking in the vicinity of the home. The storage location may be a parking lot of a work place where the user commutes on a weekday. A charging facility is to be installed or has already been installed in the storage location.

The electric vehicle is charged while being stored in the parking lot. The parking time of the internal combustion engine vehicle 40 is acquired based on the travel information. On the basis of the parking time thus acquired and the charging performance of the charging equipment for charging the electric vehicle, the amount of the electric energy (rechargeable amount) that can be charged to the electric vehicle in the home parking lot is acquired. The ratio estimation unit 120 estimates a rechargeable ratio. The rechargeable ratio indicates a ratio of the rechargeable amount in the home parking lot to the electric energy required when the electric vehicle is used for the predetermined period.

The output unit 130 causes the information terminal 30 of the user to output the rechargeable ratio estimated by the ratio estimation unit 120.

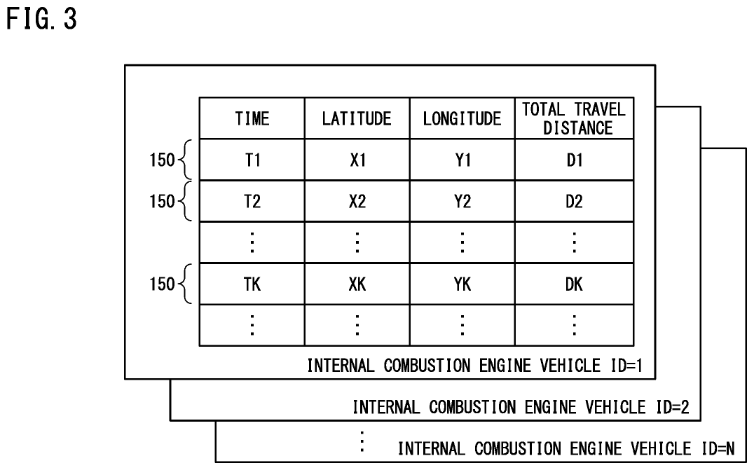

FIG. 3 is a diagram exemplifying travel information 150. The travel information 150 includes a travel history of the internal combustion engine vehicle 40. The travel history is obtained from various sensors mounted on the internal combustion engine vehicle 40. As shown in FIG. 3, the travel information 150 includes a travel history relating to at least time, a location of the travel point, and a total travel distance. The location of the travel is expressed by latitude and longitude. The travel information 150 may further include a travel history regarding speed, acceleration, engine torque, remaining fuel amount, and the like. The travel information 150 is repeatedly transmitted from the internal combustion engine vehicle 40 to the simulation device 10.

When the travel information acquisition unit 100 of the simulation device 10 acquires the travel information 150 from a plurality of internal combustion engine vehicles 40, the travel information acquisition unit 100 stores each travel information 150 in the storage device 70 in association with a vehicle ID of each of the internal combustion engine vehicles 40. In the example shown in FIG. 3, travel information 150 of N internal combustion engine vehicles 40 is stored. Each vehicle ID of the internal combustion engine vehicle 40 is associated with a user ID of each user and a terminal ID of the information terminal 30 operated by each user, in the storage device 70.

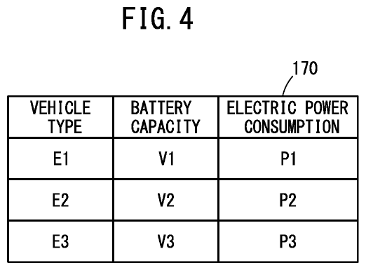

FIG. 4 is a diagram exemplifying electric vehicle information 170. The electric vehicle information 170 is stored in advance in the storage device 70 for each vehicle type of electric vehicle. The electric vehicle information 170 includes a battery capacity and an electric power consumption relating to the traveling performance of the electric vehicle. In the example shown in FIG. 4, battery capacities V1, V2, and V3 are stored corresponding to electric vehicles of vehicle types E1, E2, and E3, respectively. Electric power consumptions P1, P2, and P3 are stored corresponding to the electric vehicles of the vehicle types E1, E2, and E3, respectively. In the present embodiment, the charging performance of the charging equipment installed in the home parking lot is a performance value corresponding to ordinary charging equipment for home use.

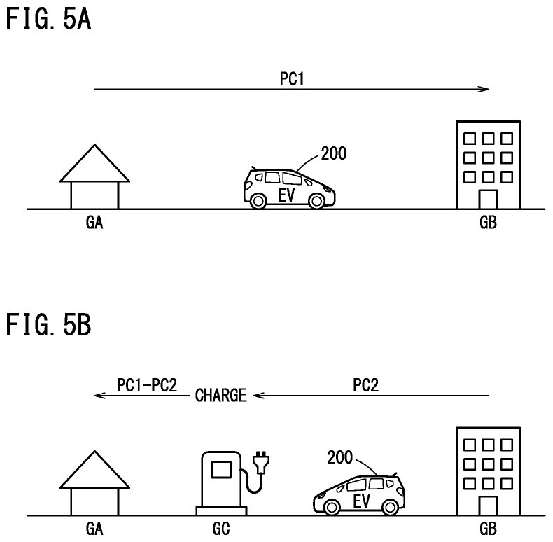

FIG. 5A is a diagram illustrating a state in which the user drives an electric vehicle 200 from a home parking lot to his/her work place. FIG. 5A shows electric energy PC1 necessary for the electric vehicle 200 to travel on an outward route from point GA where the home parking lot is located to point GB where the work place is located. In this embodiment, the electric vehicle 200 is not charged at the work place.

FIG. 5B is a diagram illustrating how the user returns to the home parking lot by the electric vehicle 200 from the work place. For simplicity of explanation, it is assumed that the estimated value of the electric energy required for the electric vehicle 200 to travel on a homeward route from the point GB where the workplace is located to the point GA where the home parking lot is located is the electric energy PC1 equal to the electric energy required for the outward route. In an example shown in FIG. 5B, when electric energy PC2 is consumed after the electric vehicle 200 departs from the point GB, the remaining amount of energy in the battery of the electric vehicle 200 becomes 0.

If a charging facility exists at point GC where the remaining amount of energy in the battery of the electric vehicle 200 becomes 0, the electric vehicle 200 is charged at the point GC. Thus, the user can return from the point GC to the point GA by the electric vehicle 200. The electric energy required for the electric vehicle 200 to travel from the point GC to the point GA is equal to a difference between the electric power PC1 and the electric power PC2.

In the examples shown in FIGS. 5A and 5B, electric energy PN required to make a round trip between the point GA and the point GB is 2×PC1. Rechargeable amount PA in the home parking lot is acquired based on the parking time. Rechargeable ratio PR is expressed as PA/PN. If the electric vehicle 200 travels only one round trip between the point GA and the point GB at the same time every day, the rechargeable ratio PR in one day is estimated to be PA/(2×PC1).

If the rechargeable amount PA obtained based on the parking time exceeds a battery capacity shown in FIG. 4, the rechargeable amount PA becomes equal to the battery capacity.

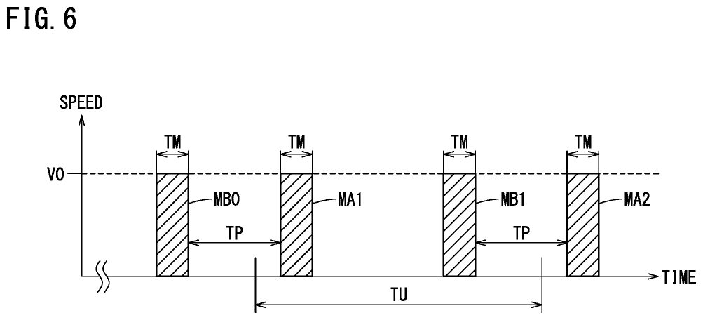

FIG. 6 is a diagram for explaining the travel of the internal combustion engine vehicle 40 during a predetermined period TU and each parking time TP of the internal combustion engine vehicle 40 in the parking lot. For simplicity of explanation, FIG. 6 illustrates a simple example. The predetermined period TU is, for example, one day. At the same time every day, the user goes from the home parking lot to the work place by the internal combustion engine vehicle 40, and returns from the work place to the home parking lot by the internal combustion engine vehicle 40. The travel distance of the internal combustion engine vehicle 40 in the outward route is equal to the travel distance of the internal combustion engine vehicle 40 in the homeward route. When the user travels by the internal combustion engine vehicle 40 between the home parking lot and the work place, an average speed V0 is the same value on the outward route and the homeward route. Therefore, the travel time on the outward route and the travel time on the homeward route of the internal combustion engine vehicle 40 are equal to each other, and both are TM. An average one-day travel history is shown in FIG. 6, although variations occur from day to day actually.

FIG. 6 shows each parking time TP from the time when the internal combustion engine vehicle 40 finishes homeward travel MB0 on the previous day to the time when the internal combustion engine vehicle 40 starts outward travel MA1 on the current day, in one day designated as the predetermined period TU. As described above, the internal combustion engine vehicle 40 travels at the same time every day for the same distance at the average speed V0. Therefore, the parking time from the time when the internal combustion engine vehicle 40 finishes the homeward travel MB1 on the current day to the time when the outward travel MA2 is started on the next day is equal to the parking time TP. In this case, the parking time of the internal combustion engine vehicle 40 in the home parking lot for one day as the predetermined period TU is equal to the above-described parking time TP. The parking time TP is estimated based on the time, the location of the travel point, and the total travel distance included in the travel information 150 of the predetermined period TU (one day).

When the user uses the electric vehicle 200 as in the example shown in FIG. 6, the above-described rechargeable ratio PR is estimated as follows. The vehicle type of the electric vehicle 200 is E1 shown in FIG. 4. The electric energy PN required when the electric vehicle 200 is used for the predetermined period TU is calculated based on the travel distance of the round trip and the electric power consumption P1 of the vehicle type E1. The travel distance for the round trip is calculated based on the time, the location of the travel point, and the total travel distance contained in the travel information 150. In the example shown in FIG. 6, the travel distance of the round trip is indicated by 2×V0×TM. The rechargeable amount PA in the home parking lot is calculated based on the parking time TP and the charging performance values of the charging equipment. Therefore, the rechargeable ratio PR (=PA/PN) can be calculated.

In the case where the vehicle type of the electric vehicle 200 is E2 or E3 shown in FIG. 4, the rechargeable ratio PR (=PA/PN) can be calculated similarly to the case of the vehicle type E1.

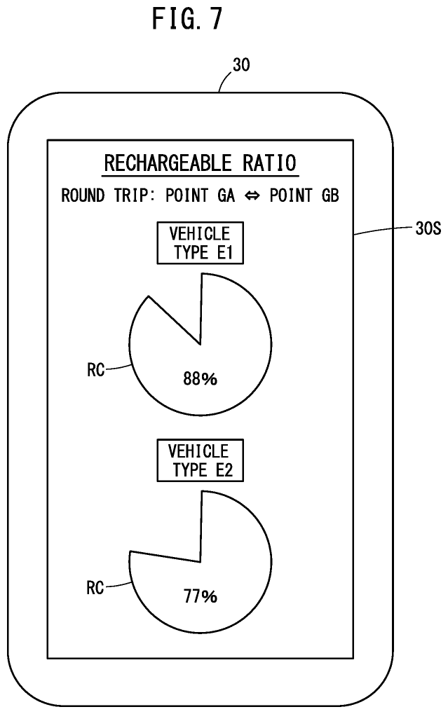

FIG. 7 is a diagram illustrating a state where a rechargeable ratio PR is output to the information terminal 30 of the user. On a screen 30S of the information terminal 30, pie charts RC of the rechargeable ratio PR are displayed corresponding to the vehicle types E1 and E2, respectively. When scrolled or swiped, a pie chart RC of the rechargeable ratio PR corresponding to the vehicle type E3 may be displayed on the screen 30S.

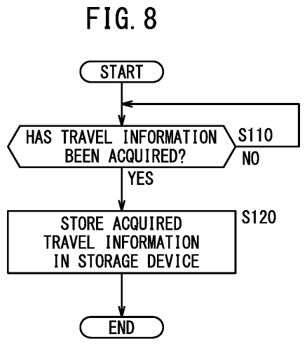

FIG. 8 is a flowchart illustrating a processing procedure relating to acquisition of the travel information 150 by the simulation device 10. This processing procedure is performed, for example, by the processing circuit 60 of the simulation device 10 executing a program stored in the storage device 70. When this processing procedure is started, in step S110, the travel information acquisition unit 100 determines whether or not the travel information 150 has been acquired from the internal combustion engine vehicle 40. If YES in step S110, the process proceeds to step S120. If NO in step S110, the process returns to step S110.

In step S120, the travel information acquisition unit 100 stores the acquired travel information 150 in the storage device 70, in association with the ID of the internal combustion engine vehicle 40. When the processing of step S120 is completed, this processing procedure is terminated.

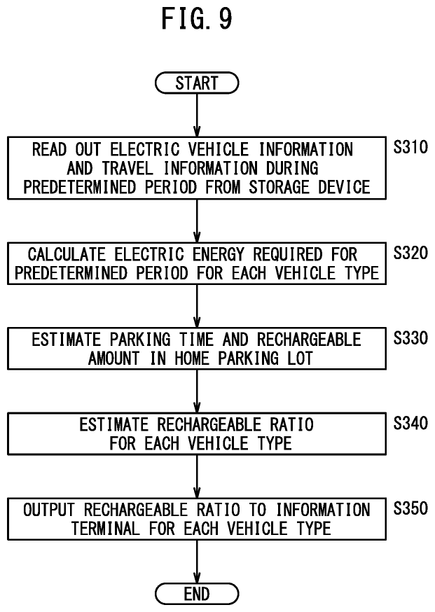

FIG. 9 is a flowchart illustrating a processing procedure relating to estimation of the rechargeable ratio PR by the simulation device 10. This processing procedure is performed, for example, by the processing circuit 60 of the simulation device 10 executing a program stored in the storage device 70. When this processing procedure is started, in step S310, the electric energy calculating unit 110 reads out the electric vehicle information 170 and the travel information 150 acquired during the predetermined period TU from the storage device 70.

In step S320, the electric energy calculating unit 110 calculates electric energy PN required for the predetermined period TU for each vehicle type of the electric vehicle 200. In step S330, the ratio estimation unit 120 estimates the parking time TP based on the travel information 150 acquired during the predetermined period TU. Based on the parking time TP, the ratio estimation unit 120 estimates the rechargeable amount PA in the home parking lot. In step S340, the ratio estimation unit 120 estimates the rechargeable ratio PR for each vehicle type of the electric vehicle 200.

In step S350, the output unit 130 outputs the rechargeable ratio PR to the information terminal 30 of the user for each vehicle type of the electric vehicle 200. When the processing of step S350 is completed, this processing procedure is terminated.

### [Modifications]

The above-described embodiment may be modified as follows.

In the above-described embodiment, the output unit 130 outputs the rechargeable ratio PR corresponding to the user to the information terminal 30 of the user. However, in addition to the rechargeable ratio PR corresponding to the user, an average value of the rechargeable ratios PR of a plurality of users may be output to the information terminal 30.

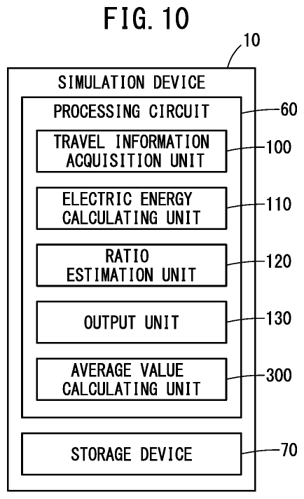

FIG. 10 is a block diagram illustrating the configuration of the simulation device 10 according to a modification. The processing circuit 60 further includes an average value calculating unit 300. The average value calculating unit 300 is also realized by the processing circuit 60 executing a program stored in the storage device 70.

The ratio estimation unit 120 estimates a rechargeable ratio PR for each of the users of the plurality of internal combustion engine vehicles 40. The ratio estimation unit 120 stores the rechargeable ratio PR for each user in the storage device 70. The average value calculating unit 300 calculates an average value AV of the rechargeable ratios PR, based on the rechargeable ratio PR for each user stored in the storage device 70. The average value AV of the rechargeable ratios PR is calculated, for example, by a simple average of the rechargeable ratios PR for each vehicle type. The output unit 130 causes the information terminal 30 to output the rechargeable ratio PR together with its average value AV.

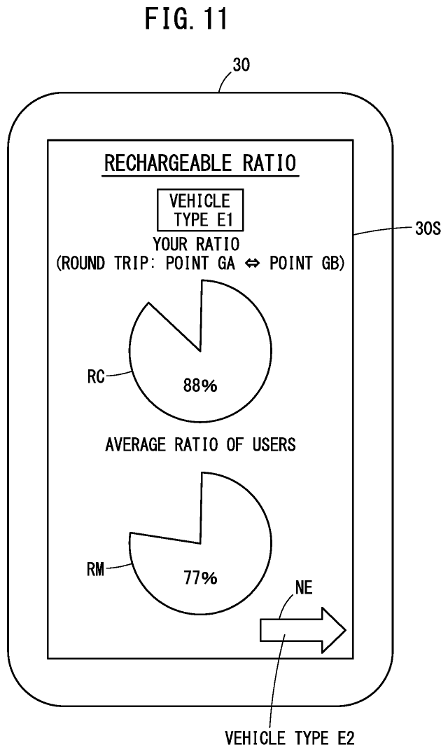

FIG. 11 is a diagram illustrating a state where the rechargeable ratio PR is output to the information terminal 30 of the user. On the screen 30S of the information terminal 30, a pie chart RC of the rechargeable ratio PR corresponding to the user and a pie chart RM corresponding to the average value AV of the rechargeable ratios PR are displayed for comparison. The example shown in FIG. 11 corresponds to the vehicle type E1. When an icon NE labeled “vehicle type E2” displayed on the screen 30S is operated, a display for comparison corresponding to the vehicle type E2 is output in a similar manner to FIG. 11.

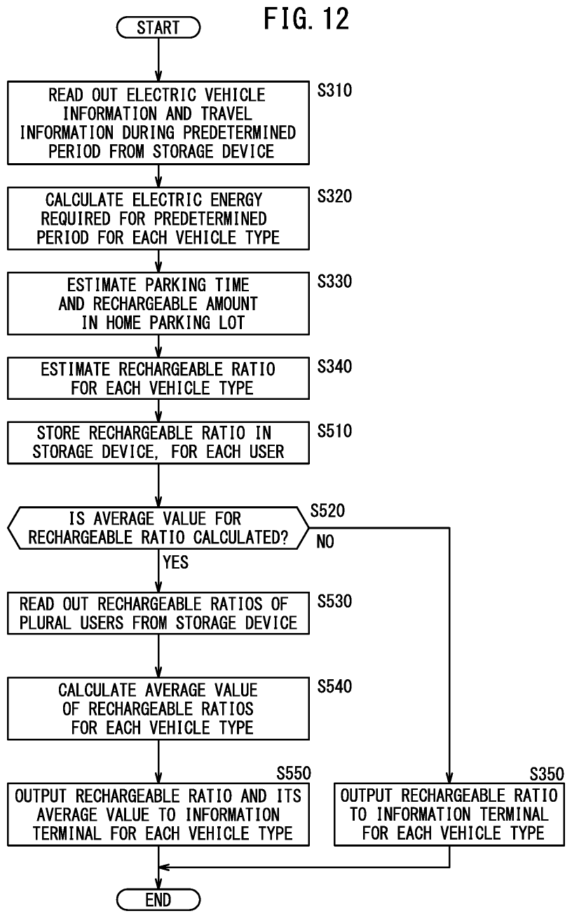

FIG. 12 is a flowchart illustrating a processing procedure relating to estimation of the rechargeable ratio PR and calculation of the average value AV by the simulation device 10. This processing procedure is performed, for example, by the processing circuit 60 of the simulation device 10 executing a program stored in the storage device 70. The reference characters assigned to the steps of this processing procedure shown in FIG. 12 and the reference characters assigned to the steps of the processing procedure shown in FIG. 9 partially coincide with each other. Since the same processing is executed in each step having the same reference character, the description thereof in the step is omitted.

When the processing of step S340 is completed, the processing procedure proceeds to step S510. In step S510, the ratio estimation unit 120 stores the rechargeable ratio PR estimated for each of the vehicle types of the electric vehicles 200 in the storage device 70, for each user. In step S520, the average value calculating unit 300 determines whether or not to calculate an average value AV for the rechargeable ratio PR. When the user operates the information terminal 30, whether or not to calculate the average value AV for the rechargeable ratio PR is designated. In response to the designation by the user, the determination in step S520 is performed.

If YES in step S520, the processing procedure proceeds to step S530. If NO in step S520, the processing procedure proceeds to step S350 described above. In step S530, the average value calculating unit 300 reads out the rechargeable ratios PR of the plurality of users from the storage device 70.

In step S540, the average value calculating unit 300 calculates the average value AV of the rechargeable ratios PR for each of the vehicle types of the electric vehicles 200. In step S550, the output unit 130 outputs the rechargeable ratio PR and its average value AV to the information terminal 30 of the user for each of the vehicle types of the electric vehicles 200. When the processing of step S550 is completed, this processing procedure is terminated.

[Invention Obtained from Embodiment]

A description will be given below concerning invention that can be grasped from the above-described embodiment and the modifications.

(1) The simulation device (10) includes the travel information acquisition unit (100) configured to acquire travel information (150) from the internal combustion engine vehicle (40) equipped with the internal combustion engine, the travel information including the travel history of the internal combustion engine vehicle, the storage device (70) configured to store electric vehicle information (170) about traveling performance of the electric vehicle (200), the electric energy calculating unit (110) configured to calculate electric energy (PN) required when the electric vehicle is used during the predetermined period (TU), based on the electric vehicle information and the travel information acquired during the predetermined period, the ratio estimation unit (120) configured to estimate the rechargeable ratio (PR) in the storage location, based on the calculated electric energy and the parking time (TP) of the internal combustion engine vehicle in the storage location, and the output unit (130) configured to cause the information terminal (30) of the user of the internal combustion engine vehicle to output the rechargeable ratio. As a result, it is possible to encourage the user to make a replacement purchase of a vehicle.

(2) The electric vehicle may include the plurality of electric vehicles, and the storage device may store the electric vehicle information for each of vehicle types (E1, E2) of the electric vehicles, and the ratio estimation unit may estimate the rechargeable ratio for each of the vehicle types in the ratio estimation, and the output unit may cause the information terminal to output the rechargeable ratio for each of the vehicle types. Thus, the user can consider purchasing an electric vehicle by comparing the rechargeable ratios for the respective vehicle types.

(3) The internal combustion engine vehicle may include the plurality of internal combustion engine vehicles, and the travel information acquisition unit may acquire the travel information from the plurality of the internal combustion engine vehicles, the ratio estimation unit may estimate the rechargeable ratio for each of users of the plurality of internal combustion engine vehicles, the simulation device may further include the average value calculating unit (300) configured to calculate the average value (AV) for the rechargeable ratio based on the rechargeable ratio for each of the users, and the output unit may cause the information terminal to output the rechargeable ratio together with the average value. Thus, the user can compare his/her rechargeable ratio with the average rechargeable ratio of users and consider purchasing an electric vehicle.

The present invention is not limited to the above disclosure, and various modifications are possible without departing from the essence and gist of the present invention.

1. A simulation device comprising:
a storage device configured to store electric vehicle information about traveling performance of an electric vehicle; and
one or more processors that execute computer-executable instructions stored in a memory,
wherein the one or more processors execute the computer-executable instructions to cause the simulation device to:
perform travel information acquisition to acquire travel information from an internal combustion engine vehicle equipped with an internal combustion engine, the travel information including a travel history of the internal combustion engine vehicle;
calculate electric energy required when the electric vehicle is used during a predetermined period, based on the electric vehicle information and the travel information acquired during the predetermined period;
make a ratio estimation to estimate a rechargeable ratio in a storage location, based on the calculated electric energy and a parking time of the internal combustion engine vehicle in the storage location; and
cause an information terminal of a user of the internal combustion engine vehicle to output the rechargeable ratio.

2. The simulation device according to claim 1, wherein the electric vehicle comprises a plurality of electric vehicles, the storage device stores the electric vehicle information for each of vehicle types of the electric vehicles, and
the one or more processors are configured to:
estimate the rechargeable ratio for each of the vehicle types in the ratio estimation; and
cause the information terminal to output the rechargeable ratio for each of the vehicle types.

3. The simulation device according to claim 1, wherein the internal combustion engine vehicle comprises a plurality of internal combustion engine vehicles, and
the one or more processors are configured to:
acquire the travel information from the plurality of internal combustion engine vehicles in the travel information acquisition;
estimate the rechargeable ratio for each of users of the plurality of internal combustion engine vehicles in the ratio estimation;
calculate an average value for the rechargeable ratio based on the rechargeable ratio for each of the users; and
cause the information terminal to output the rechargeable ratio together with the average value.

4. The simulation device according to claim 2, wherein the internal combustion engine vehicle comprises a plurality of internal combustion engine vehicles, and
the one or more processors are configured to:
acquire the travel information from the plurality of internal combustion engine vehicles in the travel information acquisition;
estimate the rechargeable ratio for each of users of the plurality of internal combustion engine vehicles in the ratio estimation;
calculate an average value for the rechargeable ratio based on the rechargeable ratio for each of the users; and
cause the information terminal to output the rechargeable ratio together with the average value.
